(19) United States
(12) Patent Application Publication
(10) Pub. No.: US 2026/0302004 A1
(43) Pub. Date: Oct. 1, 2026

(54) HIGH VOLTAGE DIVIDER RESISTOR

(71) Applicant: YAGEO CORPORATION, Kaohsiung City (TW)

(72) Inventors: Shen-Li HSIAO, Kaohsiung City (TW); Po-Hsun SHIH, Kaohsiung City (TW)

(21) Appl. No.: 19/232,838

(22) Filed: Jun. 9, 2025

(30) Foreign Application Priority Data
Apr. 1, 2025 (TW) 114112621

(51) Int. Cl. H01C 1/16; H01C 7/10

(52) U.S. Cl. CPC H01C 1/16; H01C 7/10

(57) ABSTRACT

A high voltage divider resistor includes a thick film resistor, first thin film resistors, at least one second thin film resistor, a thin film capacitor and a varistor disposed on a substrate. The thick film resistor and the first and second thin film resistors are connected in series through a first input inner electrode and first series electrodes. A resistance value of the second thin film resistor is smaller than that of each first thin film resistor. A resistance value of the thick film resistor is smaller than 0.5% of a series resistance of the second and first thin film resistors. The thin film capacitor and the varistor are connected in parallel with the thick film resistor and the first and second thin film resistors through the first input inner electrode and a first output outer electrode to prevent damages caused by static electricity and instantaneous high voltage surges.

### CROSS-REFERENCE TO RELATED APPLICATIONS

This application claims priority to Taiwan Application Serial Number 114112621, filed Apr. 1, 2025, which is herein incorporated by reference.

### BACKGROUND

### Field of Invention

The present disclosure relates to a technology for manufacturing an electronic component, and more particularly, to a high voltage divider resistor.

### Description of Related Art

Currently, high voltage divider circuits, such as front-stage voltage divider sensing circuits of battery management systems (BMS), on the market use electrodes to connect various chip resistors in series on the circuit board directly, and use the difference in resistance values between the electrodes to achieve voltage distribution.

However, the resistors are connected in series by using the same manufacturing process. That is, the resistors connected in series are all manufactured by using thick film processes or by using thin film processes. However, different manufacturing processes of the resistors result in different characteristics of the resistors. For example, when the resistor products are subjected to surges or static electricity shocks, the resistance values of the thick film resistors will decrease, while the resistance values of the thin film resistors will increase. Therefore, the accuracy and the stability of the voltage division of the high voltage divider resistor composed of thick film resistors or thin film resistors connected in series need to be enhanced.

### SUMMARY

Therefore, one objective of the present disclosure is to provide a high voltage divider resistor, in which a thick film resistor and thin film resistors are connected in series on the same chip, such that the high voltage divider resistor can have a surge absorption capability of the thick film resistor and the accuracy of the thin film resistors, thereby making the voltage division of high voltage divider resistor more accurate and stable.

According to the aforementioned objectives, the present disclosure provides a high voltage divider resistor. The high voltage divider resistor includes a substrate, a first input inner electrode, a first output inner electrode, plural first series inner electrodes, a thick film resistor, plural first thin film resistors, at least one second thin film resistor, a thin film capacitor, a first insulating protection layer, plural second inner electrodes, a second insulating protection layer, plural outer electrodes, a diamagnetic isolation layer, and a third insulating protection layer. The substrate has a first surface and a second surface that are opposite to each other. The first input inner electrode and the first output inner electrode are respectively disposed on two opposite sides of the first surface. The first series inner electrodes are arranged on the first surface along a direction from the first input inner electrode toward the first output inner electrode. The thick film resistor is straddled on the first input inner electrode and an adjacent one of the first series inner electrodes. The first thin film resistors and the at least one second thin film resistor are sequentially straddled on the first series inner electrodes and are separated from each other. A resistance value of each of the at least one second thin film resistor is smaller than a resistance value of each of the first thin film resistors. A resistance value of the thick film resistor is smaller than 0.5% of a series resistance value of the at least one second thin film resistor and the first thin film resistors. The thin film capacitor is disposed on the first surface and includes a first electrode and a second electrode that are spaced apart. The first electrode is connected to the first input inner electrode, and the second electrode is connected to the first output inner electrode. The first insulating protection layer covers the first surface and exposes at least one portion of the first input inner electrode, a portion of the first output inner electrode, and a first one and a last one of the first series inner electrodes on which the at least one second thin film resistor is straddled. The second inner electrodes are disposed on the first insulating protection layer, and respectively cover the portions of the first input inner electrode and the first output inner electrode, and the first one and the last one of the first series inner electrodes on which the at least one second thin film resistor is straddled. The second insulating protection layer covers the first surface and the first insulating protection layer and exposes a connection portion of each of the second inner electrodes. The outer electrodes are respectively disposed on the connection portions. The diamagnetic isolation layer is disposed on the second surface. The third insulating protection layer covers the diamagnetic isolation layer.

According to one embodiment of the present disclosure, the high voltage divider resistor further includes a third inner electrode and a varistor. The third inner electrode is disposed on the first surface, extends from the first input inner electrode toward the first output inner electrode, and is spaced apart from the first output inner electrode. The varistor is straddled on the third inner electrode and the first output inner electrode. A resistance value of the varistor is more than 20 times the series resistance value. An operating voltage of the varistor is more than 1.2 times a maximum operating voltage of the high voltage divider resistor.

According to one embodiment of the present disclosure, the high voltage divider resistor further includes two glass protection layers covering the thick film resistor and the varistor respectively.

According to one embodiment of the present disclosure, a distance between the first series inner electrodes on which each of the first thin film resistors is straddled is from 2 to 4 times a distance between the first series inner electrodes on which each of the at least one second thin film resistor is straddled.

According to one embodiment of the present disclosure, each of the first thin film resistors and the at least one second thin film resistor has plural trimming grooves, and a spacing between the trimming grooves is ranging from 10 μm to 30 μm.

According to one embodiment of the present disclosure, a distance between the first electrode and the second electrode is greater than 30 μm and smaller than 3000 μm. The first electrode or each of the first electrode and the second electrode includes a symmetrical tip portion, in which a tip angle of the symmetrical tip portion is ranging from 30 degrees to 90 degrees.

According to one embodiment of the present disclosure, the at least portion of the first input inner electrode exposed by the first insulating protection layer includes a first portion and a second portion. The first portion is opposite the exposed portion of the first output inner electrode, and the second portion is adjacent to the thick film resistor.

According to one embodiment of the present disclosure, a first one, a second one, and a third one of the second inner electrodes are respectively disposed on the second portion of the first input inner electrode, and the first one and the last one of the first series inner electrodes on which the at least one second thin film resistor is straddled. A fourth one, a fifth one, and a sixth one of the second inner electrodes are respectively disposed on the first portion of the first input inner electrode, the exposed portion of the first output inner electrode, and the first insulating protection layer between the fourth one and the fifth one. The connection portions of the first one, the second one, and the third one of the second inner electrodes, and the connection portions of the fourth one, the fifth one, and the sixth one of the second inner electrodes are all arranged at equal intervals.

According to one embodiment of the present disclosure, the high voltage divider resistor further includes an electromagnetic wave isolation layer. The electromagnetic wave isolation layer is disposed on the first insulating protection layer, and is located between the first one, the second one, and the third one of the second inner electrodes and the fourth one, the fifth one, and the sixth one of the second inner electrodes.

According to one embodiment of the present disclosure, the high voltage divider resistor further includes a marking point, in which the marking point is disposed on the third insulating protection layer.

According the above embodiments, the high voltage divider resistor of the present disclosure connects a thick film resistor, first thin film resistors with high resistance values, and at least one second thin film resistor with a low resistance value in series, such that it can have the surge absorption capability of the thick film resistor and the accuracy of the thin film resistors, which can enhance the accuracy and the stability of voltage division of the high voltage divider resistor. The ratio of the resistance value of the thick film resistor is designed to be smaller than 0.5% of the series resistance value of the first thin film resistors and the second thin film resistor. Therefore, although the resistance value of the thick film resistor decreases due to the surge changes, the impact due to the decrease of the resistance value of the thick film resistor on the overall resistance value can be reduced to the thousandth level, and the decrease of the resistance value of the thick film resistor has little impact on the resistance value of the high voltage divider resistor.

In addition, the thick film resistor, the first thin film resistors, and the second thin film resistor, which are connected in series, are connected in parallel with a ground electrode and a thin film capacitor, and can be additionally connected in parallel with a varistor (MOV), such that the damage caused by instantaneous high voltage surges and static electricity can be prevented. Furthermore, electroplated copper layers of an antimagnetic isolation layer and second inner electrodes can reduce electromagnetic interference and a risk of a sulfide environment.

Moreover, the thick film resistor, the first thin film resistors, and the second thin film resistor of the high voltage divider resistor of the present disclosure are fabricated on the same chip. Therefore, compared with the traditional circuit application that uses multiple independent resistor chips in series for voltage sampling signals, the high voltage divider resistor of the present disclosure can eliminate the accuracy differences in resistance value matching between the independent chips, and has better measurement accuracy, better sampling accuracy of temperature resistance differences, and lower sampling noise differences. The circuit layout is changed from the traditional multi-chip resistor wiring to a single chip resistor, such that the layout space can be greatly reduced, and the space application of the circuit board and the cost advantage can be greatly increased.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 is a schematic three-dimensional diagram of a high voltage divider resistor in accordance with one embodiment of the present disclosure.

FIG. 2 is a schematic diagram of a front side of a high voltage divider resistor in accordance with one embodiment of the present disclosure.

FIG. 3 is a schematic diagram of a solder side of a high voltage divider resistor in accordance with one embodiment of the present disclosure.

FIG. 4 is a schematic diagram of internal devices of a high voltage divider resistor in accordance with one embodiment of the present disclosure.

FIG. 5 is an equivalent circuit diagram of a high voltage divider resistor in accordance with one embodiment of the present disclosure.

FIG. 6 is a schematic cross-sectional view of the high voltage divider resistor taken along a section line A-A in FIG. 1.

FIG. 7 is a schematic cross-sectional view of the high voltage divider resistor taken along a section line B-B in FIG. 1.

FIG. 8 is a schematic cross-sectional view of the high voltage divider resistor taken along a section line C-C in FIG. 1.

FIG. 9 through FIG. 21 respectively illustrate schematic diagrams of various manufacturing stages of a high voltage divider resistor in accordance with one embodiment of the present disclosure.

FIG. 22 is a partial schematic diagram of another pattern of a film capacitor of a high voltage divider resistor in accordance with one embodiment of the present disclosure.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms “first”, “second”, and the like, as used herein, are not intended to mean a sequence or order, and are merely used to distinguish elements or operations described in the same technical terms.

The spatial relationship between two elements described in the present disclosure applies not only to the orientation depicted in the drawings, but also to the orientations not represented by the drawings, such as the orientation of the inversion. Moreover, the terms “connected”, “electrically connected”, or the like between two components referred to in the present disclosure are not limited to the direct connection or electrical connection of the two components, and may also include indirect connection or electrical connection as required.

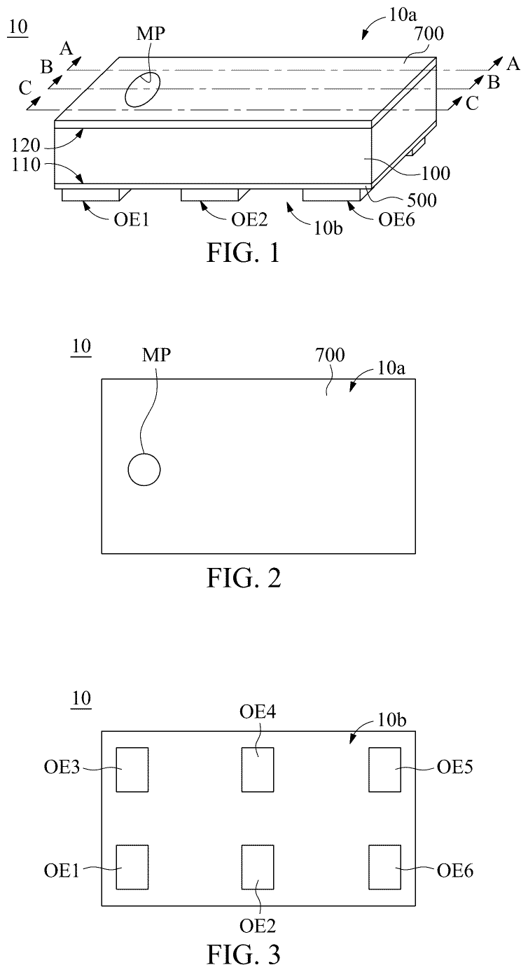

Referring to FIG. 1 through FIG. 5, FIG. 1 through FIG. 5 respectively illustrate a schematic three-dimensional diagram of a high voltage divider resistor 10 in accordance with one embodiment of the present disclosure, schematic diagrams of a front side 10a and a solder side 10b of the high voltage divider resistor 10, a schematic diagram of internal devices of the high voltage divider resistor 10, and an equivalent circuit diagram of the high voltage divider resistor 10. The high voltage divider resistor 10 can be used in medical, communications, automotive specification applications, such as automotive charging piles, battery management systems (BMS), and engine control units (ECU), or voltage sensing applications. As shown in FIG. 1, the high voltage divider resistor 10 is of flip chip type.

As shown in FIG. 2, the front side 10a of the high voltage divider resistor 10 may be provided with a marking point MP for identifying positions of soldering pins of the high voltage divider resistor 10. As shown in FIG. 3, in some examples, the solder side 10b of the high voltage divider resistor 10 is provided with six solder pins, which are specifically implemented by outer electrodes OE1 to OE6. The outer electrode OE1 is a high voltage input pin. The outer electrodes OE2 and OE3 are auxiliary soldering pins, which serve as balancing structures during soldering and have no electrical effect. The outer electrode OE4 is a voltage output pin of thin film resistors with high resistance values. The outer electrode OE5 is a voltage output pin of a thin film resistor with a low resistance value. The outer electrode OE6 is a ground pin.

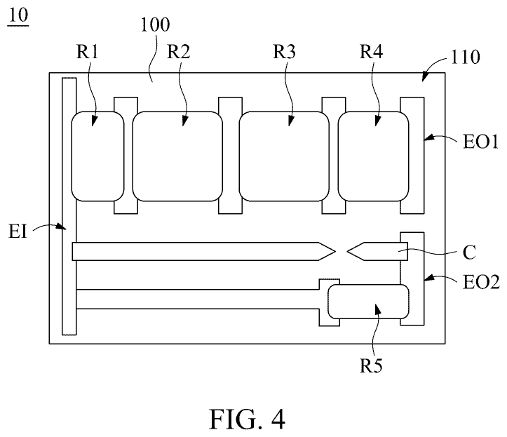

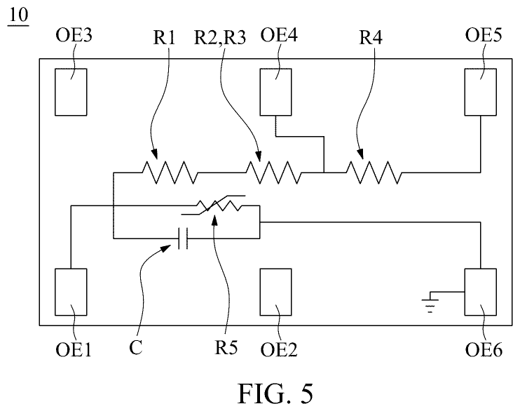

As shown in FIG. 4, in some examples, the high voltage divider resistor 10 is manufactured by forming a thick film resistor R1, first thin film resistors R2 and R3 with high resistance values, a second thin film resistor R4 with a low resistance value, and a thin film capacitor C on the same substrate 100, such that the devices are integrated into the same chip. The high voltage divider resistor 10 may be optionally added with a varistor R5. The thick film resistor R1, the first thin film resistors R2 and R3, and the second thin film resistor R4 are connected in series with each other, and then connected in parallel with the thin film capacitor C and the varistor R5 respectively. All the devices share an input terminal electrode EI. However, an output terminal electrode EO1 of the thick film resistor R1, the first thin film resistors R2 and R3, and the second thin film resistor R4 that are connected in series, is not connected to an output terminal electrode EO2 of the thin film capacitor C and the varistor R5 that are connected in parallel with them. The output terminal electrode EO2 is a ground terminal. The equivalent circuit diagram of the high voltage divider resistor 10 is shown in FIG. 5.

The thick film resistor R1 has a low resistance value and can provide a function of absorbing surges. The first thin film resistors R2 and R3 with the high resistance values and the second thin film resistor R4 with the low resistance value are used for partial voltage measurement. The thin film capacitor C is an electrostatic discharge (ESD) protection device to prevent damage caused by static electricity. The varistor R5 can prevent damage from instantaneous high voltage surges.

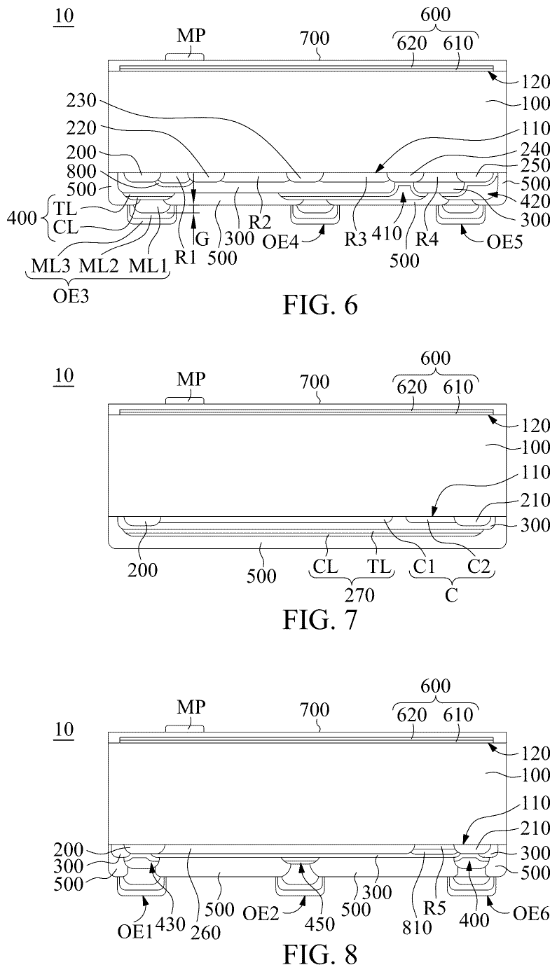

Referring to FIG. 6 through FIG. 8 together, FIG. 6 through FIG. 8 illustrate schematic cross-sectional views of the high voltage divider resistor 10 taken along section lines A-A, B-B, and C-C in FIG. 1 respectively. The high voltage divider resistor 10 may mainly include a substrate 100, a first input inner electrode 200, a first output inner electrode 210, plural first series inner electrodes 220, 230, 240, and 250, a thick film resistor R1, plural first thin film resistors R2 and R3, at least one second thin film resistor R4, a thin film capacitor C, a first insulating protection layer 300, plural second inner electrodes 400, 410, 420, 430, 440, and 450, a second insulating protection layer 500, plural outer electrodes OE1 through OE6, a diamagnetic isolation layer 600, and a third insulating protection layer 700.

The substrate 100 has a first surface 110 and a second surface 120 respectively located on two opposite sides of the substrate 100. For example, the substrate 100 may be a rectangular parallelepiped or a cube. However, the substrate 100 may be a plate body with other suitable shapes, and the present disclosure is not limited thereto. For example, a material of the substrate 100 may be aluminum oxide (Al₂O₃), aluminum nitride (AlN), boron nitride (BN), zirconium oxide toughened alumina (ZTA), silicon dioxide (SiO₂), or silicon carbide (SiC).

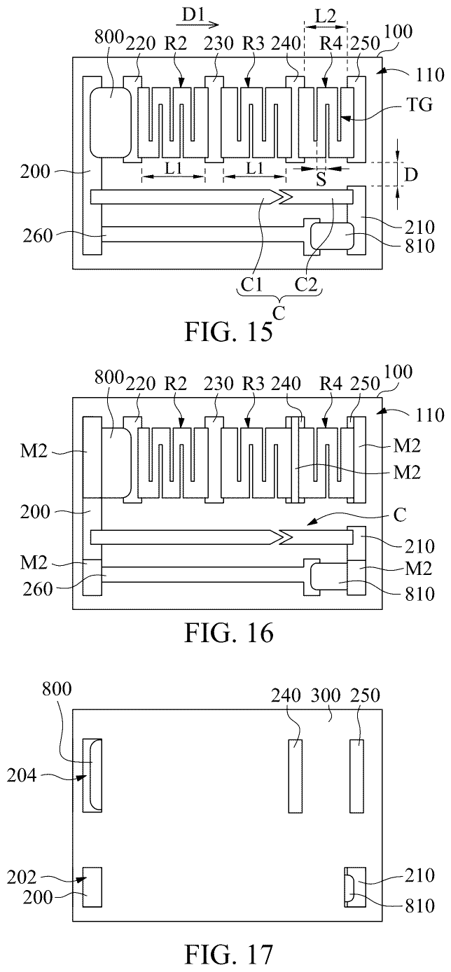

Referring to FIG. 15 together, the first input inner electrode 200 and the first output inner electrode 210 are both disposed on the first surface 110 of the substrate 100. The first input inner electrode 200 and the first output inner electrode 210 are respectively located on two opposite sides of the first surface 110, such as two opposite edge areas of the first surface 110. The first series inner electrodes 220, 230, 240, and 250 are separately arranged on the first surface 110 along a direction D1 from the first input inner electrode 200 toward the first output inner electrode 210. The first series inner electrodes 220, 230, 240, and 250 are arranged in sequence. For example, the first series inner electrode 250 may be adjacent to, but separated from, the first output inner electrode 210. For example, a distance D between the first series inner electrode 250 and the first output inner electrode 210 may be ranging from 0.1 mm to 0.5 mm. When the distance D is within this range, an optimized spatial layout can be obtained while effectively preventing the first series inner electrode 250 from being connected to the first output inner electrode 210.

In the example shown in FIG. 15, the first input inner electrode 200 is opposite to the first output inner electrode 210 and the first series inner electrode 250, and an extension length of the first input inner electrode 200 is greater than a sum of extension lengths of the first output inner electrode 210 and the first series inner electrode 250. The number of the first series inner electrodes 220, 230, 240, and 250 is not limited to four, and can be increased according to the increase in the number of resistors to be connected in series in the high voltage divider resistor 10.

According to the product design, the high voltage divider resistor 10 may further optionally include a third inner electrode 260. The third inner electrode 260 is also disposed on the first surface 110 and extends from the first input inner electrode 200 toward the first output inner electrode 210. The third inner electrode 260 is connected to the first input inner electrode 200 and is spaced apart from the first output inner electrode 210.

Referring to FIG. 6 and FIG. 10 simultaneously, the thick film resistor R1 is straddled on the first input inner electrode 200 and the first series inner electrode 220 adjacent to the first input inner electrode 200. The thick film resistor R1 extends from the first input inner electrode 200 through the first surface 110 to the first series inner electrode 220.

Referring to FIG. 6 and FIG. 15 simultaneously, the first thin film resistors R2 and R3 and the second thin film resistor R4 are disposed across the first series inner electrodes 220, 230, 240, and 250 in sequence and are separated from each other. Specifically, the first thin film resistor R2 extends from the first series inner electrode 220 to the first series inner electrode 230 through the first surface 110, the first thin film resistor R3 extends from the first series inner electrode 230 to the first series inner electrode 240 through the first surface 110, and the second thin film resistor R4 extends from the first series inner electrode 240 to the first series inner electrode 250 through the first surface 110. The first thin film resistor R2 shares the first series inner electrode 220 with the thick film resistor R1, and shares the first series inner electrode 230 with the first thin film resistor R3. The other side of the first thin film resistor R3 shares the first series inner electrode 240 with the second thin film resistor R4. Through the first series inner electrodes 220, 230, 240, and 250, the thick film resistor R1, the first thin film resistors R2 and R3, and the second thin film resistor R4 are connected in series with each other.

The first thin film resistors R2 and R3 are thin film resistors with the high resistance values, and the second thin film resistor R4 is a thin film resistor with a low resistance value. Therefore, the resistance value of each second thin film resistor R4 is smaller than the resistance value of each of the first thin film resistors R2 and R3. As shown in FIG. 15, there is a distance L1 between the first series inner electrodes 220 and 230 on which the first thin film resistor R2 is straddled and between the first series inner electrodes 230 and 240 on which the first thin film resistor R3 is straddled. There is a distance L2 between the first series inner electrodes 240 and 250 on which the second thin film resistor R4 is straddled. In some examples, the resistance value of the second thin film resistor R4 with the low resistance value after coating is 25% to 50% of the resistance value of each of the first thin-film resistors R2 and R3 with the high resistance values after coating, and the trimmable space of the second thin film resistor R4 is also 2 to 4 times smaller than that of the first thin film resistors R2 and R3. Therefore, the distance L1 is designed to be 2 to 4 times the distance L2.

In addition, the resistance value of the thick film resistor R1 is much smaller than the series resistance value of the first thin film resistors R2 and R3 and the second thin film resistor R4. In some examples, the resistance value of the thick film resistor R1 is smaller than 0.5% of the series resistance value of the first thin film resistors R2 and R3 and the second thin film resistor R4.

Each of the first thin film resistors R2 and R3 and the second thin film resistor R4 has plural trimming grooves TG. A spacing S between the trimming grooves TG is a width of the resistor wire after trimming. In some examples, the spacing S between the trimming grooves TG is ranging from 10 μm to 30 μm. When the spacing S is smaller than 10 μm, if the voltage is too high, any adjacent two of the resistor wires will become a capacitor and trip. In addition, the thermal effects during trimming will overlap and affect the stability of the resistor. If the spacing S is greater than 30 μm, the resistor wires will be too wide to obtain the required trimming effect.

Referring to FIG. 7 and FIG. 14, the film capacitor C is disposed on the first surface 110 of the substrate 100. The thin film capacitor C may be located at one side of the thick film resistor R1, the first thin film resistors R2 and R3, and the second thin film resistor R4 that are connected in series. The thin film capacitor C is a low capacitance capacitor. The thin film capacitor C includes a first electrode C1 and a second electrode C2 that are separated from each other. The first electrode C1 and the second electrode C2 are opposite to each other. The first electrode C1 is connected to the first input inner electrode 200, and the second electrode C2 is connected to the first output inner electrode 210, such that the thin film capacitor C is connected in parallel with the thick film resistor R1, the first thin film resistors R2 and R3, and the second thin film resistor R4. In some examples, a distance W2 between the first electrode C1 and the second electrode C2 is greater than 30 μm and smaller than 3000 μm. If the distance W2 is smaller than 30 μm, the high voltage divider resistor 10 may have insufficient voltage resistance. If the distance W2 is greater than 3000 μm, the thin film capacitor C may not have the ability to protect against static electricity.

In some examples, as shown in FIG. 14, the first electrode C1 includes a symmetrical tip portion C1t, and the second electrode C2 may include a symmetrical concave portion C2c. The symmetrical tip portion C1t faces the symmetrical concave portion C2c and can discharge toward the symmetrical concave portion C2c. Referring to FIG. 22 first, in other examples, the first electrode C1 includes a symmetrical tip portion C1t, and the second electrode C2 includes a symmetrical tip portion C2t. The symmetric tip portions C1t and C2t are opposite to each other and can discharge toward each other. For example, a tip angle θ of the symmetric tip portions C1t and C2t may be ranging from 30 degrees to 90 degrees.

For example, materials of the first thin film resistors R2 and R3, the second thin film resistor R4, and the thin film capacitor C may be high resistivity metals, such as nickel chromium alloy (NiCr), nickel chromium silicon alloy (NiCrSi), nickel chromium aluminum alloy (NiCrAl), nickel chromium aluminum silicon alloy (NiCrAlSi), nickel chromium aluminum yttrium alloy (NiCrAlY), nickel chromium tantalum molybdenum alloy (NiCrTaMo), and tantalum nitride (TaN). However, the materials of the first thin film resistors R2 and R3, the second thin film resistor R4, and the thin film capacitor C may be other suitable high resistivity resistive materials, and the present disclosure is not limited thereto.

Referring to FIG. 8 and FIG. 11, in the example that the high voltage divider resistor 10 includes the varistor R5, the varistor R5 is straddled on the third inner electrode 260 and the first output inner electrode 210. The varistor R5 extends from the third inner electrode 260 to the first output inner electrode 210 through the first surface 110. Therefore, the varistor R5 is connected in parallel with the thin film capacitor C, as well as the thick film resistor R1, the first thin film resistors R2 and R3, and the second thin film resistor R4 that are connected in series. A resistance value of the varistor R5 is more than 20 times the series resistance value of the first thin film resistors R2 and R3 and the second thin film resistor R4, such that the current does not flow through the varistor R5 as much as possible. In addition, an operating voltage (V_{1mA}) of the varistor R5 is more than 1.2 times a maximum operating voltage of the high voltage divider resistor 10.

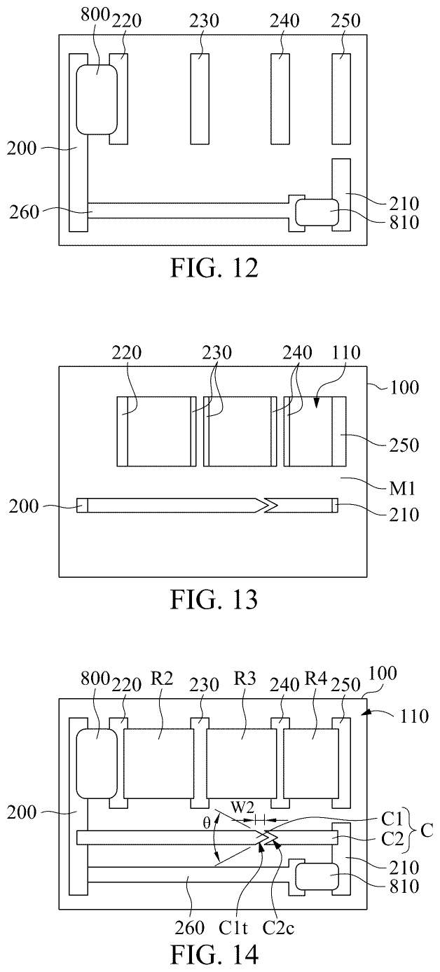

In some examples, as shown in FIG. 6, FIG. 8, and FIG. 12, the high voltage divider resistor 10 further includes two glass protection layers 800 and 810. The glass protection layer 800 covers the thick film resistor R1, and the glass protection layer 810 covers the varistor R5 to protect the thick film resistor R1 and the varistor R5 from being damaged by wet processing liquids in the subsequent processes.

Referring to FIG. 6 through FIG. 8 and FIG. 17 simultaneously, the first insulating protection layer 300 covers the first surface 110 of the substrate 100. The first insulating protection layer 300 exposes at least one portion of the first input inner electrode 200, a portion of the first output inner electrode 210, and the first series inner electrodes 240 and 250 on which the second thin film resistor R4 is straddled. In the example that the high voltage divider resistor 10 includes plural thin film resistors with the low resistance value, all the thin film resistors with the low resistance value are straddled on more than two series inner electrodes, and the first insulating protection layer 300 exposes the first one and the last one of the series inner electrodes on which the thin film resistors with the low resistance value are straddled to facilitate voltage measurement. In the example that the high voltage divider resistor 10 includes one single thin film resistor with the low resistance value, that is the second thin film resistor R4, the first series inner electrodes 240 and 250 are respectively the first one and the last one of the series inner electrodes on which the second thin film resistor R4 is straddled.

In the example shown in FIG. 17, the at least one portion of the first input inner electrode 200 exposed by the first insulating protection layer 300 includes a first portion 202 and a second portion 204. The first portion 202 is opposite the exposed portion of the first output inner electrode 210, and the second portion 204 is adjacent to the thick film resistor R1. For example, a material of the first insulating protection layer 300 may be silicon oxide, tantalum oxide, or silicon nitride.

Referring to FIG. 6 through FIG. 8 and FIG. 19, the second inner electrodes 400, 410, 420, 430, 440, and 450 are disposed on the first insulating protection layer 300. The second inner electrodes 400, 410, and 420 are arranged in one row, and the second inner electrodes 430, 440, and 450 are arranged in another row. The second inner electrodes 400, 410, and 420 are respectively disposed on the second portion 204 of the first input inner electrode 200 and the exposed portions of the first series inner electrodes 240 and 250. The second inner electrodes 430, 440, and 450 are respectively disposed on the first portion 202 of the first input inner electrode 200, the exposed portion of the first output inner electrode 210, and the first insulating protection layer 300 between the second inner electrodes 430 and 440.

Optionally, as shown in FIG. 7 and FIG. 19, the high voltage divider resistor 10 further includes an electromagnetic wave isolation layer 270. The electromagnetic wave isolation layer 270 is disposed on the first insulating protection layer 300, and is between the second inner electrodes 400, 410, and 420 in one row and the second inner electrodes 430, 440, and 450 in the other row. Specifically, the electromagnetic wave isolation layer 270 extends between the two rows to isolate electromagnetic waves when there are additional electromagnetic waves or the input and output voltages are too high.

In some examples, as shown in FIG. 6, each of the second inner electrodes 400, 410, 420, 430, 440, and 450 and the electromagnetic wave isolation layer 270 includes a titanium tungsten (TiW) layer TL and a copper layer CL stacked in sequence. The titanium tungsten layer TL is sandwiched between the first insulating protection layer 300 and the copper layer CL. The titanium tungsten layer TL is an adhesive layer, which can provide better bonding between the copper layer CL and the substrate 100 or the first insulating protection layer 300. For example, a thickness of the titanium tungsten layer TL may be ranging from 0.01 μm to 0.1 μm, and a thickness of the copper layer CL may be ranging from 0.5 μm to 5 μm. The copper layer CL with the thickness within this range can make the copper layer CL have a certain thermal conductivity thickness. If the thickness of the copper layer CL exceeds 5 μm, the sputtering time of the copper layer CL is too long, such that the underlying mask is overheated and solidified, which makes the mask be unable to be removed.

As shown in FIG. 19, in some examples, a distance G1 of the second inner electrodes 400, 410, 420, 430, 440, and 450 from the adjacent long side of the substrate 100 is ranging from 50 μm to 250 μm, and a distance G4 of the second inner electrodes 400, 410, 420, 430, 440, and 450 from the adjacent short side of the substrate 100 is ranging from 50 μm to 250 μm. A distance G3 between adjacent two of the second inner electrodes 400, 410, 420, 430, 440 and 450 in the same row is ranging from 200 μm to 2000 μm. A distance G2 between each row of the second inner electrodes 400, 410, 420, 430, 440, and 450 and the electromagnetic wave isolation layer 270 is ranging from 200 μm to 2000 μm.

Referring to FIG. 6 through FIG. 8 and FIG. 20, the second insulating protection layer 500 covers the first surface 110 of the substrate 100 and the first insulating protection layer 300, but does not cover the connection portions 402, 412, 422, 432, 442, and 452 of the second inner electrodes 400, 410, 420, 430, 440, and 450. For example, a material of the second insulating protection layer 500 may be an insulating material, such as epoxy, resin, or epoxy containing inorganic fillers. The inorganic fillers may be, for example, aluminum oxide, aluminum nitride, or silicon oxide.

In some examples, the connection portions 402, 412, 422, 432, 442 and 452 of the second inner electrodes 400, 410, 420, 430, 440, and 450 in the same row are arranged at equal intervals. That is, there is the same distance B6 between the connection portions 402 and 412, between the connection portions 412 and 422, between the connection portions 432 and 452, and between the connection portions 452 and 442. In some examples, a distance B1 of the connection portions 402, 412, 422, 432, 442, and 452 from the adjacent long side of the substrate 100 is ranging from 0.05 mm to 1.0 mm, and a distance B4 of the connection portions 402, 412, 422, 432, 442, and 452 from the adjacent short side of the substrate 100 is ranging from 0.05 mm to 1.0 mm. A width B2 of the connection portions 402, 412, 422, 432, 442, and 452 is ranging from ⅕ to ¼ of a width W of the substrate 100, and a length B5 of the connection portions 402, 412, 422, 432, 442, and 452 is ranging from 1/10 to ⅕ of a length L of the substrate 100. A distance B3 between the two rows of the connection portions 402, 412, 422, 432, 442, and 452 is ranging from ⅓ to ½ of the width W of the substrate 100.

As shown in FIG. 6, the diamagnetic isolation layer 600 is disposed on the second surface 120 of the substrate 100. In some examples, the diamagnetic isolation layer 600 includes a titanium tungsten layer 610 and a copper layer 620 stacked in sequence. The titanium tungsten layer 610 is located between the substrate 100 and the copper layer 620. The titanium tungsten layer 610 is an adhesive layer, which can provide better bonding between the copper layer 620 and the substrate 100. For example, a thickness of the titanium tungsten layer 610 may be ranging from 0.01 μm to 0.1 μm, and a thickness of the copper layer 620 may be ranging from 0.5 μm to 5 μm.

As shown in FIG. 2 and FIG. 5, the third insulating protection layer 700 covers the diamagnetic isolation layer 600. For example, a material of the third insulating protection layer 700 may be an insulating material, such as epoxy resin, resin, or epoxy containing inorganic fillers. The marking point MP is disposed on the third insulating protection layer 700 for identifying the direction of the pin electrodes.

As shown in FIG. 6 through FIG. 8 and FIG. 21, the outer electrodes OE3, OE4, OE5, OE1, OE2, and OE6 are respectively disposed on the connection portions 402, 412, 422, 432, 442, and 452. In some examples, each of the outer electrodes OE1 to OE6 includes a first metal layer ML1, a second metal layer ML2, and a third metal layer ML3 stacked in sequence. For example, the first metal layer ML1 may be a copper layer, the second metal layer ML2 may be a nickel layer, and the third metal layer ML3 may be a tin layer. As shown in FIG. 6, in some exemplary examples, a distance G between the first metal layer ML1 and the second insulation protection layer 500 is ranging from 5 μm to 20 μm.

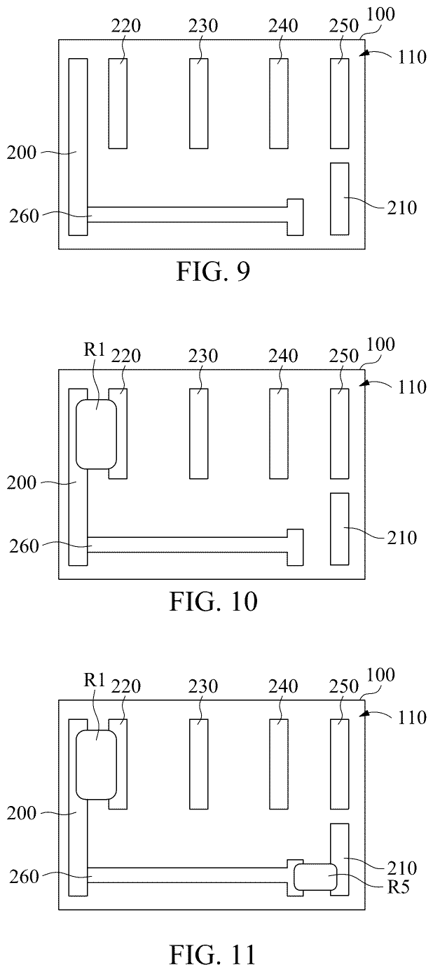

Referring to FIG. 9 through FIG. 21, FIG. 9 through FIG. 21 respectively illustrate schematic diagrams of various manufacturing stages of a high voltage divider resistor 10 in accordance with one embodiment of the present disclosure. In the manufacturing of the high voltage divider resistor 10 as shown in FIG. 1 and FIG. 6 through FIG. 8, the substrate 100 may be provided first. A first inner electrode pattern layer is formed on the first surface 110 of the substrate 100 by using, for example, a printing and sintering method. The first inner electrode pattern layer includes the first input inner electrode 200, the first output inner electrode 210, and the first series inner electrodes 220, 230, 240, and 250. As shown in FIG. 9, the first inner electrode pattern layer may optionally include the third inner electrode 260.

Materials of the first input inner electrode 200 and the first output inner electrode 210, the first series inner electrodes 220, 230, 240, and 250, and the third inner electrode 260 may be silver, copper, manganese copper (MnCu) alloy, copper nickel (CuNi) alloy, or conductive electrode paste formed by mixing nickel metal and glass. In some examples, a sintering temperature of the conductive electrode paste is ranging from 750° C. to 900° C. to match the subsequent process temperatures of the resistance layers and the glass protection structures.

Next, as shown in FIG. 10, the thick film resistor R1 is formed on the first input inner electrode 200 and the first series inner electrode 220 by using, for example, a printing and sintering method. For example, a material of the thick film resistor R1 may be conductive resistance paste containing a conductive metal, such as ruthenium oxide (RuO₂), copper nickel alloy, nickel, or platinum, and glass. A sintering temperature of the conductive resistance paste is equal to or smaller than the sintering temperature of the aforementioned conductive electrode paste. For example, the sintering temperature of the conductive resistance paste may be ranging from 750° C. to 850° C.

As shown in FIG. 11, in the example that the high voltage divider resistor 10 includes a varistor R5, the varistor R5 may be formed on the third inner electrode 260 and the first output inner electrode 210 by using, for example, a printing and sintering method. For example, a material of the varistor R5 may be a mixed resistance paste containing a semiconductor material, such as zinc oxide (ZnO), titanium oxide (TiO₂), manganese oxide (Mn₃O₄), or silicon carbide (SiC), and glass. A sintering temperature of the mixed resistance paste of the varistor R5 is equal to or smaller than the sintering temperature of the aforementioned conductive electrode paste. For example, the sintering temperature of the mixed resistance paste may be ranging from 750° C. to 850° C.

Then, as shown in FIG. 12, the glass protection layers 800 and 810 may be respectively formed on the thick film resistor R1 and the varistor R5 by using, for example, a printing and sintering method. The glass protection layer 800 completely covers the thick film resistor R1 and covers portions of the first input inner electrode 200 and the first series inner electrode 220 around the thick film resistor R1. The glass protection layer 810 completely covers the varistor R5 and covers portions of the first output inner electrode 210 and the third inner electrode 260 around the varistor R5. A sintering temperature of the glass protection layers 800 and 810 is equal to or smaller than the sintering temperature of the thick film resistor R1. For example, the sintering temperature of the glass protection layers 800 and 810 may be ranging from 400° C. to 850° C.

Next, as shown in FIG. 13, a patternable and removable mask layer M1 is formed by using, for example, printing, laminating, coating, or photolithography. The mask layer M1 covers portions of the first surface 110 of the substrate 100, the first input inner electrode 200, the first output inner electrode 210, and the first series inner electrodes 220, 230, 240, and 250, and completely covers the third inner electrode 260 and the glass protection layers 800 and 810. The areas, which are not covered by the mask layer M1, are the areas where the first thin film resistors R2 and R3, the second thin film resistor R4, and the thin film capacitor C are to be formed. For example, a material of the mask layer M1 may be photoresist, removable adhesive film, or releasable ink.

Subsequently, a thin film resistance alloy layer is sputtered on the mask layer M1 and the areas that are not covered by the mask layer M1 using, for example, a sputtering method. Then, as shown in FIG. 13, the mask layer M1 is removed by using, for example, a stripping liquid, such that the first thin film resistors R2 and R3, the second thin film resistor R4, and the thin film capacitor C are formed.

After the mask layer M1 is removed, according to product requirements, the first thin film resistors R2 and R3 and the second thin film resistor R4 may be optionally trimmed to adjust the resistance values of the first thin film resistors R2 and R3 and the second thin film resistor R4. As shown in FIG. 15, the trimming operation removes portions of the first thin film resistors R2 and R3 and the second thin film resistor R4 to form plural trimming grooves TG in the first thin film resistors R2 and R3 and the second thin film resistor R4. For example, laser or physical processing methods may be used to perform the trimming operation.

Next, as shown in FIG. 16, a patternable and removable mask layer M2 is formed by using, for example, printing, laminating, coating, or photolithography. The mask layer M2 covers portions of the first series inner electrodes 240 and 250, a portion of the first input inner electrode 200, and a portion of the first output inner electrode 210. The area, which is not covered by the mask layer M2, is the area where the first insulating protection layer 300 is to be formed. For example, a material of the mask layer M2 may be photoresist, removable adhesive film, or releasable ink.

Then, the first insulating protection layer 300 is formed to cover the mask layer M2 and the area, which is not covered by the mask layer M2, by using a sputtering method or a chemical vapor deposition method, for example. Subsequently, as shown in FIG. 17, the mask layer M2 is removed by using, for example, a stripping liquid to expose the first portion 202 and the second portion 204 of the first input inner electrode 200, the first series inner electrodes 240 and 250, and a portion of the first output inner electrode 210.

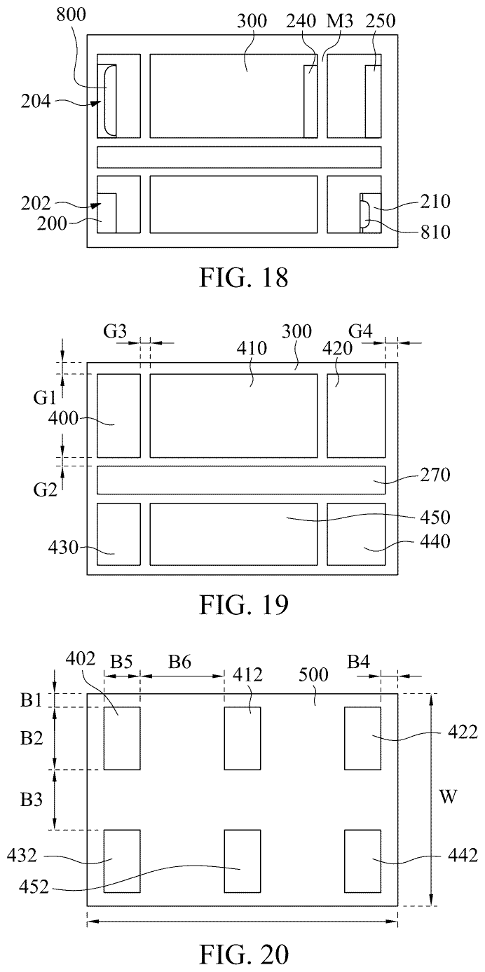

In some examples, a patternable and removable mask layer M3 may be formed by using, for example, printing, laminating, coating, or photolithography. As shown in FIG. 18, the mask layer M3 covers a portion of the first insulating protection layer 300. The areas, which are not covered by the mask layer M3, are the areas where the second inner electrodes 400, 410, 420, 430, 440, and 450 are to be formed. For example, a material of the mask layer M3 may be photoresist, removable adhesive film, or releasable ink.

Next, a metal layer may be formed to cover the mask layer M3 and the areas that are not covered by the mask layer M3 by using a sputtering method, for example. In addition, as shown in FIG. 6, the diamagnetic isolation layer 600 may be formed to cover the second surface 120 of the substrate 100 by using a sputtering method. Subsequently, as shown in FIG. 19, the mask layer M3 may be removed by using a stripping liquid, such that the second inner electrodes 400, 410, 420, 430, 440, and 450, and the electromagnetic wave isolation layer 270 are formed. In some examples, in the forming of the metal layer and the diamagnetic isolation layer 600, a titanium tungsten film and a copper film may be sputtered sequentially. Therefore, as shown in FIG. 6, each of the second inner electrodes 400, 410, 420, 430, 440, and 450, and the electromagnetic wave isolation layer 270 includes the titanium tungsten layer TL and the copper layer CL, and the diamagnetic isolation layer 600 includes the titanium tungsten layer 610 and the copper layer 620.

In other examples, a printing method can be used to directly form the second inner electrodes 400, 410, 420, 430, 440, and 450 on the first insulating protection layer 300 and the areas that are not covered by the first insulating protection layer 300, and the diamagnetic isolation layer 600 on the second surface 120 of the substrate 100.

Then, the second insulating protection layer 500 may be formed to cover a portion of each of the second inner electrodes 400, 410, 420, 430, 440, and 450 and the first insulating protection layer 300 by using printing, laminating, coating, or photolithography, for example. The second insulating protection layer 500 exposes the connection portions 402, 412, 422, 432, 442, and 452 of the second inner electrodes 400, 410, 420, 430, 440, and 450, as shown in FIG. 20.

Next, the third insulating protection layer 700 may be formed to cover the diamagnetic isolation layer 600 and the second surface 120 of the substrate 100 by using, for example, printing, laminating, coating, or photolithography. In addition, the marking point MP may be formed on the third insulating protection layer 700 by using, for example, printing, laminating, coating, or photolithography.

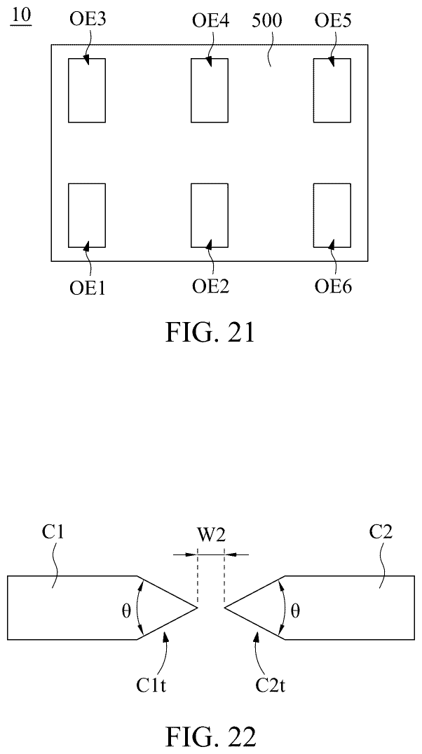

Subsequently, as shown in FIG. 21, the first metal layer ML1, the second metal layer ML2, and the third metal layer ML3 may be sequentially formed on the connection portions 402, 412, 422, 432, 442, and 452 to form the outer electrodes OE3, OE4, OE5, OE1, OE2, and OE6 by using, for example, an electroplating method. So far, the manufacturing of the high voltage divider resistor 10 has been roughly completed.

According to the above embodiments, the high voltage divider resistor of the present disclosure connects a thick film resistor, a first thin film resistor with high resistance values, and at least one second thin film resistor with a low resistance value in series, such that it can have the surge absorption capability of the thick film resistor and the accuracy of the thin film resistors, which can enhance the accuracy and the stability of voltage division of the high voltage divider resistor.

In addition, the thick film resistor, the first thin film resistors, and the second thin film resistor, which are connected in series, are connected in parallel with a ground electrode and a thin film capacitor, and can be additionally connected in parallel with a varistor, such that the damage caused by instantaneous high voltage surges and static electricity can be prevented. Furthermore, electroplated copper layers of an antimagnetic isolation layer and second inner electrodes can reduce electromagnetic interference and a risk of a sulfide environment.

Moreover, the thick film resistor, the first thin film resistors, and the second thin film resistor of the high voltage divider resistor of the present disclosure are fabricated on the same chip. Therefore, compared with the traditional circuit application that uses multiple independent resistor chips in series, the high voltage divider resistor can eliminate the accuracy differences in resistance value matching between the independent chips, and has better measurement accuracy, better sampling accuracy of temperature resistance differences, and lower sampling noise differences. The circuit layout is a single chip resistor, such that the layout space can be greatly reduced, and the space application of the circuit board and the cost advantage can be greatly increased.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. A high voltage divider resistor, comprising:
a substrate having a first surface and a second surface that are opposite to each other;
a first input inner electrode and a first output inner electrode respectively disposed on two opposite sides of the first surface;
a plurality of first series inner electrodes arranged on the first surface along a direction from the first input inner electrode toward the first output inner electrode;
a thick film resistor straddled on the first input inner electrode and an adjacent one of the first series inner electrodes;
a plurality of first thin film resistors and at least one second thin film resistor sequentially straddled on the first series inner electrodes and separated from each other, wherein a resistance value of each of the at least one second thin film resistor is smaller than a resistance value of each of the first thin film resistors, and a resistance value of the thick film resistor is smaller than 0.5% of a series resistance value of the at least one second thin film resistor and the first thin film resistors;
a thin film capacitor disposed on the first surface and comprising a first electrode and a second electrode that are spaced apart, wherein the first electrode is connected to the first input inner electrode, and the second electrode is connected to the first output inner electrode;
a first insulating protection layer covering the first surface and exposing at least one portion of the first input inner electrode, a portion of the first output inner electrode, and a first one and a last one of the first series inner electrodes on which the at least one second thin film resistor is straddled;
a plurality of second inner electrodes disposed on the first insulating protection layer, and respectively covering the portions of the first input inner electrode and the first output inner electrode, and the first one and the last one of the first series inner electrodes on which the at least one second thin film resistor is straddled;
a second insulating protection layer covering the first surface and the first insulating protection layer and exposing a connection portion of each of the second inner electrodes;
a plurality of outer electrodes respectively disposed on the connection portions;
a diamagnetic isolation layer disposed on the second surface; and
a third insulating protection layer covering the diamagnetic isolation layer.

2. The high voltage divider resistor of claim 1, further comprising:
a third inner electrode disposed on the first surface, extending from the first input inner electrode toward the first output inner electrode, and spaced apart from the first output inner electrode; and
a varistor straddled on the third inner electrode and the first output inner electrode, wherein a resistance value of the varistor is more than 20 times the series resistance value, and an operating voltage of the varistor is more than 1.2 times a maximum operating voltage of the high voltage divider resistor.

3. The high voltage divider resistor of claim 2, further comprising two glass protection layers covering the thick film resistor and the varistor respectively.

4. The high voltage divider resistor of claim 1, wherein a distance between the first series inner electrodes on which each of the first thin film resistors is straddled is from 2 to 4 times a distance between the first series inner electrodes on which each of the at least one second thin film resistor is straddled.

5. The high voltage divider resistor of claim 1, wherein each of the first thin film resistors and the at least one second thin film resistor has a plurality of trimming grooves, and a spacing between the trimming grooves is ranging from 10 μm to 30 μm.

6. The high voltage divider resistor of claim 1, wherein
a distance between the first electrode and the second electrode is greater than 30 μm and smaller than 3000 μm; and
the first electrode or each of the first electrode and the second electrode comprises a symmetrical tip portion, wherein a tip angle of the symmetrical tip portion is ranging from 30 degrees to 90 degrees.

7. The high voltage divider resistor of claim 1, wherein the at least portion of the first input inner electrode exposed by the first insulating protection layer comprises a first portion and a second portion, the first portion is opposite the portion of the first output inner electrode, and the second portion is adjacent to the thick film resistor.

8. The high voltage divider resistor of claim 7, wherein
a first one, a second one, and a third one of the second inner electrodes respectively disposed on the second portion of the first input inner electrode, and the first one and the last one of the first series inner electrodes on which the at least one second thin film resistor is straddled;
a fourth one, a fifth one, and a sixth one of the second inner electrodes respectively disposed on the first portion of the first input inner electrode, the portion of the first output inner electrode, and the first insulating protection layer between the fourth one and the fifth one; and
the connection portions of the first one, the second one, and the third one of the second inner electrodes, and the connection portions of the fourth one, the fifth one, and the sixth one of the second inner electrodes are all arranged at equal intervals.

9. The high voltage divider resistor of claim 8, further comprising an electromagnetic wave isolation layer, wherein the electromagnetic wave isolation layer is disposed on the first insulating protection layer, and is located between the first one, the second one, and the third one of the second inner electrodes and the fourth one, the fifth one, and the sixth one of the second inner electrodes.

10. The high voltage divider resistor of claim 1, further comprising a marking point, wherein the marking point is disposed on the third insulating protection layer.
